(19) United States
(12) Patent Application Publication
(10) Pub. No.: US 2024/0367624 A1
(43) Pub. Date: Nov. 7, 2024

(54) AUTOMATED WHEEL CHOCK

(71) Applicants: Cory A. LEASE, Big Lake, MN (US); Daniel P. WESTBY, Milaca, MN (US)

(72) Inventors: Cory A. LEASE, Big Lake, MN (US); Daniel P. WESTBY, Milaca, MN (US)

(21) Appl. No.: 18/648,106

(22) Filed: Apr. 26, 2024

Related U.S. Application Data
(60) Provisional application No. 63/463,875, filed on May 3, 2023.

(51) Int. Cl. B60T 3/00

(52) U.S. Cl. CPC B60T 3/00

(57) ABSTRACT

Disclosed are devices, systems and methods for chocking tires of a vehicle such as a truck or a trailer (including semi-trailers and fifth-wheel trailers). The automated chocking system can be mounted to the frame of the vehicle via a universal mount. The chock body is pivotally mounted to a linkage that can be selectively deployed and retracted remotely via an actuator. The actuator can be located, for example, in the cab of the truck. The chock body is pivoted from the retracted position downward towards the wheel and ground until it is placed into the nip area between the tire and pavement. The actuator can be driven pneumatically, hydraulically or electrically.

### PRIORITY

This application claims priority to and the benefit of U.S. Provisional Patent Application No. 63/463,875, filed May 3, 2023, which is incorporated fully herein by reference.

### FIELD

The present invention relates generally to wheel chocks, and, more particularly, to methods and systems of automating wheel chocks mounted to trucks and trailers.

### BACKGROUND

Vehicles, such as trucks, as well as cargo and recreational trailers, typically must have their wheels chocked while docked and while being loaded/unloaded. This ensures that the vehicle or trailer does not move away from the dock when being loaded or unloaded.

Typically the vehicle driver or dock worker must manually place a wheel chock in front of a tire on the rear of the vehicle. Either the driver or the dock worker must locate and place the chocks consistently and correctly. However, due to human error and/or intentional or accidental neglect, the chocks are not always placed correctly or placed at all for every loading/unloading process. For example, due to uncomfortable or inconvenient weather such as snow, or simply due to time pressure, sometimes the vehicle or trailer wheels are not properly chocked. This creates a safety risk.

There have been efforts to automate the chocking process. However, these efforts have focused on configurations of automated chocks that deploy from the ground or that are attached to a building. Such chocking systems are prohibitively expensive for some businesses.

Other automated systems are only adapted to work for a limited configuration of vehicle or trailer. For example, it is known to provide a dock locking system for semi-trailers. But such systems do not work for straight trucks or semi-trailers with lift gates, or for fifth-wheel trailers.

Therefore, there is a need to provide an improved wheel chocking system, device and method that can be mounted directly to vehicles, trucks and trailers, and automatedly be deployed and retracted.

### SUMMARY

Disclosed are devices, systems and methods for chocking tires of a vehicle such as a truck or a trailer (including semi-trailers and fifth-wheel trailers). The automated chocking system can be mounted to the frame of the vehicle via a universal mount. The chock body is pivotally mounted to a linkage that can be selectively deployed and retracted remotely via an actuator. The actuator can be located, for example, in the cab of the truck. The chock body is pivoted from the retracted position downward towards the wheel and ground until it is placed into the nip area between the tires and pavement. The actuator can be driven pneumatically, hydraulically or electrically.

A control system controls the actuation and operation of the chock actuator. The control system also interfaces with the vehicle's control system to ensure that the chock does not deploy if the vehicle is not in park. Visual and audio indicators, such as lights and/or buzzers can be provided to remind the driver to deploy the chocks when the vehicle is placed in park. Deployment can also be automatic upon placing the vehicle's transmission in park. Indicator lights outside the vehicle's cab (or elsewhere such as the rear of the vehicle or inside of the box) can be provided to visually notify the dock attendant that the vehicle is chocked. These external lights provide an at-a-glance verification that the chocks are in place.

In one example herein a wheel chock system for mounting on a frame of a vehicle comprises a linkage, a wheel chock body coupled to the linkage, an actuator coupled to the linkage, and a housing secured to the frame of the vehicle. The linkage is configured to move the wheel chock body between a fully retracted position and a fully deployed position. In the fully deployed position, the wheel chock body is disposed in a nip area between an outer circumference of a tire of the vehicle and a pavement surface.

The housing can be sized and shaped to fully enclose the linkage, the actuator and the wheel chock body when the wheel chock body is in the fully retracted position.

The actuator can be a pneumatically, hydraulically or electrically driven cylinder with an extendable member.

The wheel chock body can be coupled to the linkage via a flexible member.

The linkage can comprise a bell crank pivotally coupled to the actuator and to the housing, a crank link pivotally coupled to the bell crank, a drive link pivotally coupled to the housing on a first end of the drive link, and the drive link coupled to the crank link, a lower control link and an upper control link. The drive link is pivotally coupled to the lower control link at a second end of the drive link. The drive link is coupled to the crank link at a location between the first and second ends of the drive link. The upper control link is pivotally coupled to the housing at a first end of the upper control link and couped to the lower control link at a second end of the upper control link. The wheel chock body is coupled to the lower control link.

The wheel chock body is coupled to the lower control link via a flexible member spanning between the wheel chock body and the lower control link.

A sensor flag can be provided to the first end of the upper control link. A chock latched sensor can be provided to the housing. The chock latched sensor is positioned such that when the wheel chock body is in a fully retracted position, the sensor flag is sensed by the chock latched sensor. A status light can be provided to indicate that the chock latched sensor does not sense the presence of the sensor flag.

A chock down sensor can be provided to the housing. The chock down sensor is positioned such that when the wheel chock body is in a fully deployed position, the sensor flag is sensed by the chock down sensor. A status light can be provided to indicate that the chock down sensor senses the presence of the sensor flag. A status light can be provided to indicate that the chock down sensor does not sense the presence of the sensor flag.

A pivoting cylinder mount can be disposed adjacent to the actuator. The pivoting cylinder mount includes a latch member. A latch pin is disposed on the linkage, such as on the lower control link, in a position such that the latch member engages the latch pin when the wheel chock body is in the fully retracted position.

In another example herein, a method of automatically chocking a wheel of a vehicle is provided. The method comprises securing a wheel chock system to a frame of the vehicle, actuating an actuator to cause a linkage to move a wheel chock body from a fully retracted position towards a fully deployed position, continuing to the movement of the wheel chock body towards the wheel until the wheel chock body is disposed in a nip area between an outer circumference of a tire on the wheel and a pavement surface, and maintaining a force on the wheel chock body via the actuator to ensure that the wheel chock body is maintained in the nip area until the actuator is actuated to begin retracting the wheel chock body.

A chock latched sensor can be provided to sense that the wheel chock body is in the fully retracted position. A chock down sensor can be provided to sense that the wheel chock body is in the fully deployed position.

A pivoting latch member can be engaged with a latch pin on the linkage to retain the wheel chock body in the fully retracted position.

A status light can be illuminated when the wheel chock body is in the fully deployed position. A status light can be illuminated when the wheel chock body is not in the fully retracted position. A status light can be illuminated when the wheel chock body leaves the fully retracted/latched position.

A switch can be provided in the cab or passenger compartment of the vehicle to actuate the actuator.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a side view of an automated wheel chocking system attached to a truck frame according to certain example embodiments.

FIG. 2 is a side view of the automated wheel chocking system of FIG. 1 in a fully retracted state according to certain example embodiments.

FIGS. 3-7 are time-ordered side views of the deployment of the automated wheel chocking system from the fully retracted state to the fully deployed state according to certain example embodiments.

FIGS. 8-11 are time-ordered side views of the retraction of the automated wheel chocking system from the fully deployed state to the fully retracted state according to certain example embodiments.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

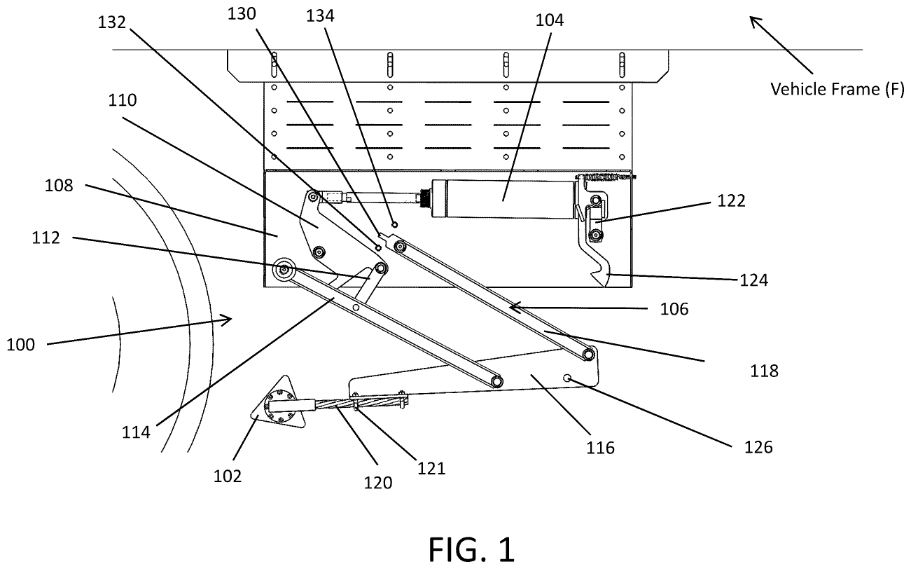

Referring to FIGS. 1-11 generally, and FIG. 1 in particular, the automated wheel chock system or device 100 generally comprises a wheel chock body 102 coupled to an actuator 104 via a linkage 106. A housing 108 is provided that at least partially contains or encloses the automated wheel chock system 100.

The housing 108 can be mounted to a rigid portion of the vehicle such as a longitudinal frame member (F). The actuator 104 and portions of the linkage 106 are secured to at least one vertically-oriented surface of the housing 108 as discussed herein and shown in the figures.

The linkage 106 comprises a bell crank 110 that is pivotally mounted to the housing 108. One end of the bell crank 110 is pivotally coupled to the actuator (here depicted as a pneumatic cylinder). The opposing end of the bell crank 110 is pivotally coupled to a crank link 112. The crank link 112 is then pivotally coupled to a drive link 114. One end of the drive link 114 is pivotally coupled to the housing 108. The opposing end of the drive link 114 is pivotally coupled to a lower control link 116. In addition, an upper end of an upper control link 118 is pivotally coupled to the housing 108. A lower end of the upper control link 118 is pivotally coupled to the lower control link 116. The wheel chock body 102 is coupled to the lower control link 116 via a flexible member 120 that extends longitudinally from an end of the lower control link 116. The flexible member 120 can be secured to the lower control link 116 via a bracket 121 or other mechanical fastening means.

Disposed adjacent to the actuator 104 is a pivoting cylinder mount 122. Attached to the pivoting cylinder mount 122 is a latch member 124. A corresponding latch pin 126 is provided to the lower control link 116. The latch member 124 and the latch pin 126 are configured to engage with one another so that the wheel chock body 102 can be secured in the retracted position when the wheel chock 100 is not being used.

Attached to the upper control link 118 is a sensor flag 130. When the wheel chock system 100 is in the fully up or retracted position, the sensor flag 130 will engage a chock latched confirmation sensor 132. Anytime the chock latched confirmation sensor 132 is not engaged by the sensor flag 130, a notification is provided to the driver in the form of a status light as explained herein below, to inform the driver that the chock is not in the fully up or retracted position.

When the wheel chock system 100 is fully deployed, the sensor flag 130 will engage a chock down confirmation sensor 134. If the chock system 100 does not fully deploy, the chock down confirmation sensor 134 will not be triggered. If the linkage 106 travels farther than normal (as would be the case if the wheel chock body 102 were not present), the chock down sensor 134 would not trigger. In either case, a notification is made to the driver that the wheels of the vehicle are not safely chocked.

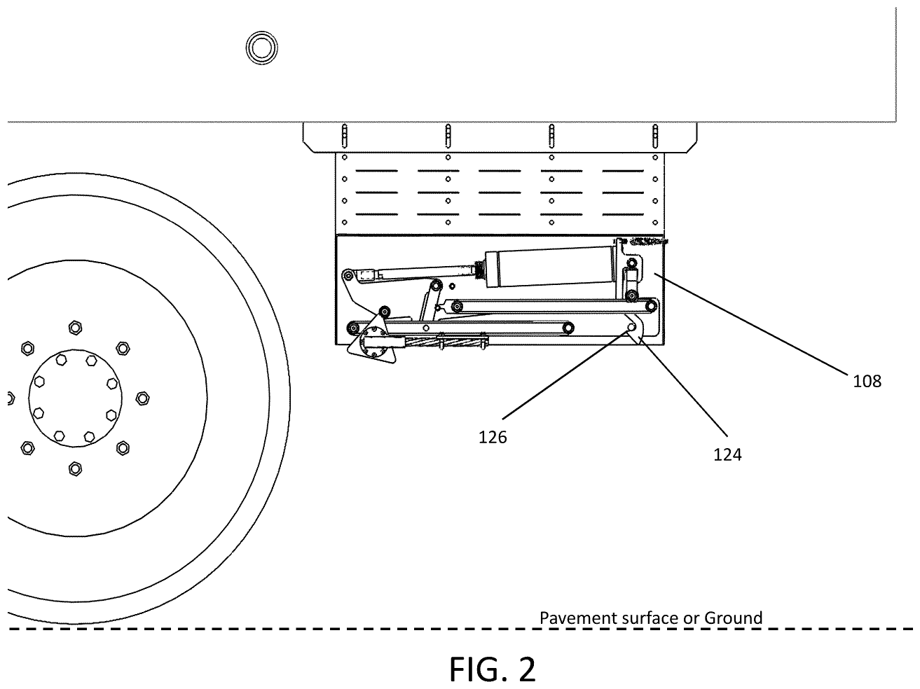

FIG. 2 illustrates the automated wheel chock system 100 in its fully raised or retracted state. The latch member 124 and the latch pin 126 are engaged to secure the system 100 in this state. Also, the wheel chock system 100 is fully contained inside of the outer perimeter of the housing 108.

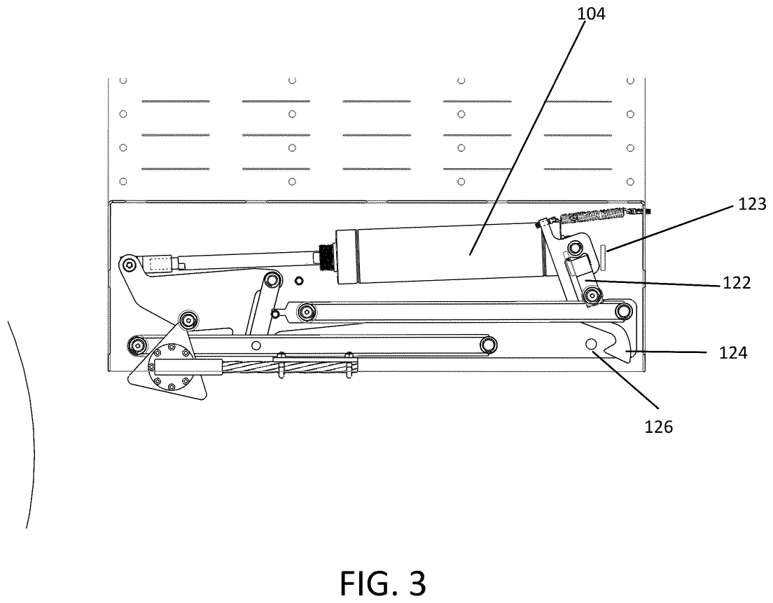

FIG. 3 illustrates the automated wheel chock system 100 as it begins deploying. The pivoting actuator mount 122 is pivoted as the actuator 104 begins to move, which disengages the latch member 124 from the latch pin 126. A stop tab 123 is provided to define a maximum pivot range of the pivoting actuator mount 122.

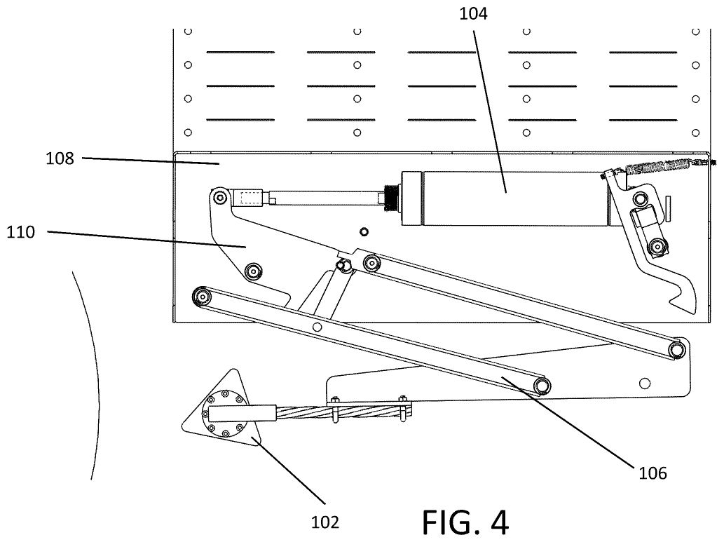

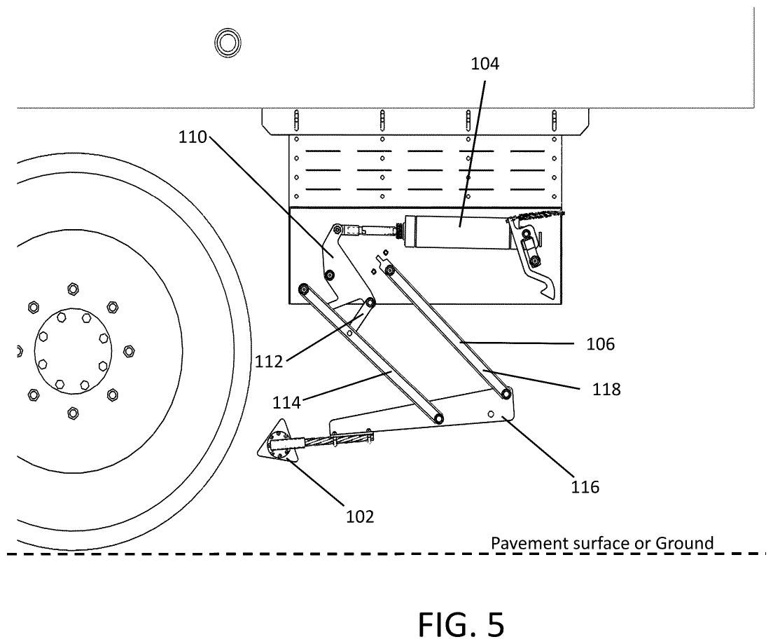

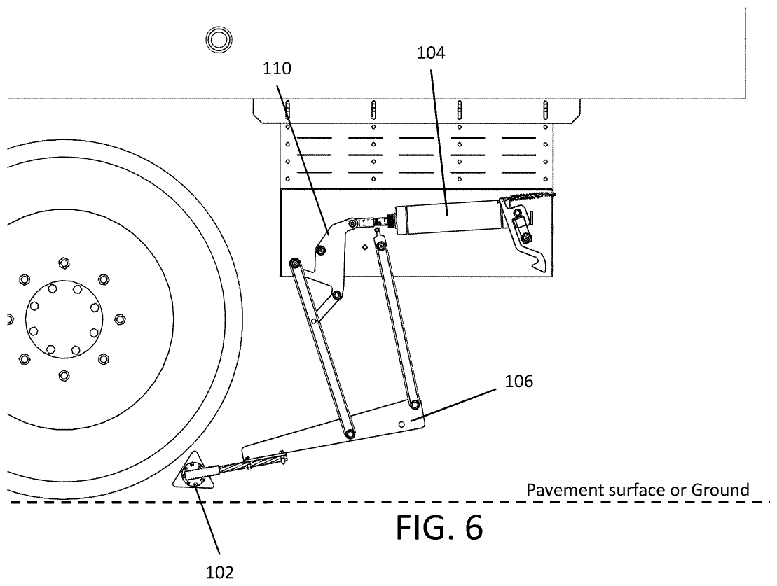

In FIG. 4, as the actuator 104 retracts, the linkage 106 begins lowering below the housing 108 and guiding the wheel chock body 102 downward towards the tire of the vehicle. FIG. 5 shows the linkage 106 further pivoted as the actuator 104 continues to retract and the wheel chock body 102 further approaches the vehicle's wheel. Note that the respective pivot locations and lengths of the bell crank 110, crank link 112, drive link 114, the lower control link 116, and upper control link 118 of the linkage 106 are selected to define the movement path of the wheel chock body 102 as it travels towards the vehicle's wheel. FIG. 6 shows further movement of the linkage 106 to the degree where the wheel chock body 102 passes horizontally past the outer boundary of the tire of the vehicle.

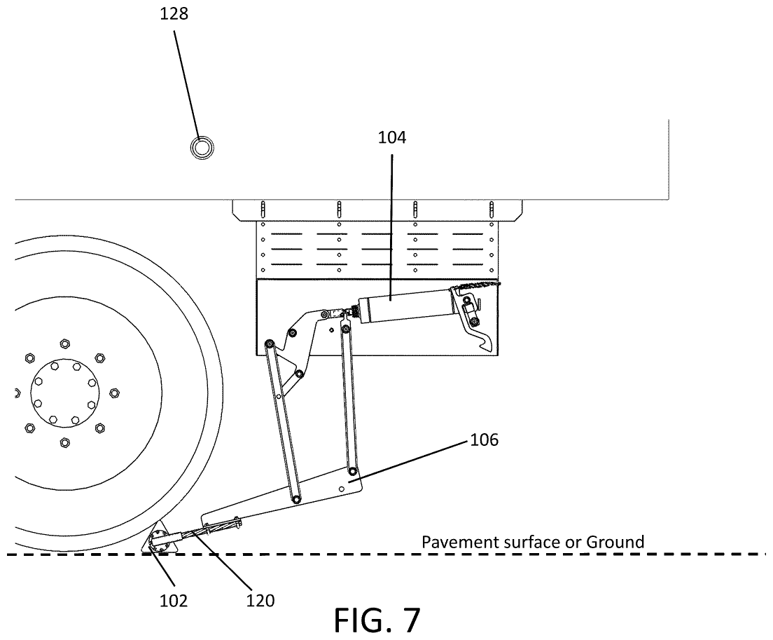

Next, FIG. 7 shows the automated wheel chock system 100 having reached the fully deployed or lowered state. A pavement surface or ground line is indicated via the dashed line in FIG. 7 for spatial reference. The wheel chock body 102 in the fully deployed position is disposed in the nip area between the tire's outer circumferential surface and the pavement surface. In addition, the actuator 104 continues to apply pressure to the linkage 106 to help ensure that the wheel chock body 102 does not disengage the tire or allow the tire to move forward such that the vehicle creeps away from the dock. The flexible member 120 ensures that variations in the pavement and/or vehicle suspension height are accommodated. The flexible member 120 also accommodates weight changes due to loading and unloading operations.

A status indicator light 128 is also shown in FIG. 7 as being disposed on the vehicle. The light can also be disposed on the housing 108, in the cab of the vehicle, or in any other conspicuous area. Multiple status indicator lights 128 can also be provided in different locations. The status indicator light 128 illuminates to provide a visual confirmation to the driver and dock attendants that the vehicle's wheels are successfully chocked. The light 128 can be varied to indicate different statuses. For example, the light 128 can be green when the wheels are successfully chocked, red when the system 100 encounters a fault condition and yellow during deployment or retraction operations. Variations of colors can be employed as well as flashing of the light 128 in alternative embodiments. Audible beeps, buzzes, sirens and other sounds can also be employed to provide an audible indication of chocking status.

The status of the wheel chock body 102 can be determined via the actuation of the sensors 132, 134 by the flag 130. When the chock body 102 is in the correct deployed position, the chock down confirmation sensor 134 and sensor flag 130 meet to turn on the chock deployed status light or illuminate the status light 128 a corresponding color (such as green). If the chock body 102 does not fully deploy or if the linkage 106 travels too far, the chock down confirmation sensor 134 will not see the flag 134 and the status light 128 will not illuminate to confirm a successful chocking engagement. Instead, the light can be illuminated a different color (such as red) to indicate to the driver and dock workers that the chock body 102 has not fully engaged the tire of the vehicle. In one example the status light 128 can be illuminated red as soon as the automated wheel chock is activated from its fully retracted position to move towards the fully deployed position, and only upon reaching the fully deployed position will the status light 128 change to green. Of course, multiple different status lights can be provided instead of a color changing status light.

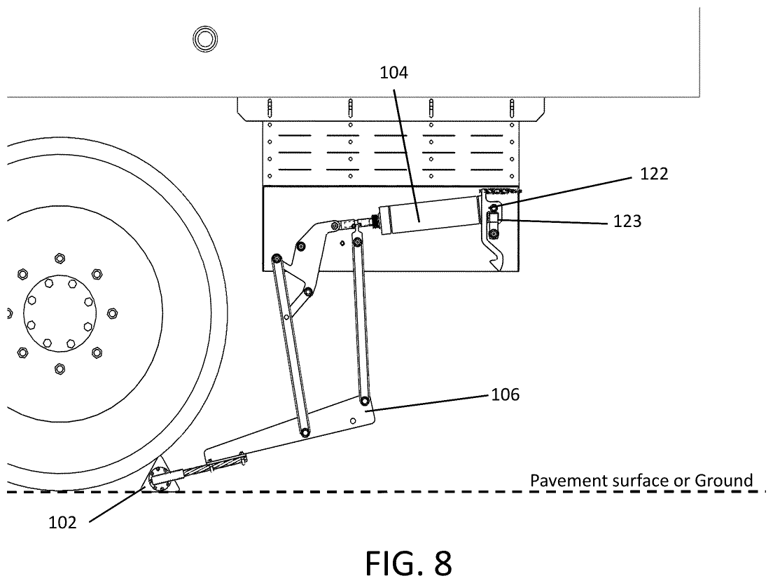

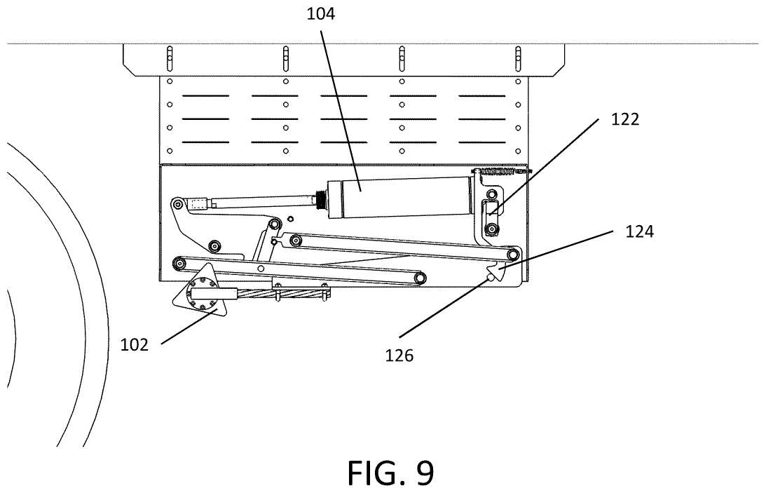

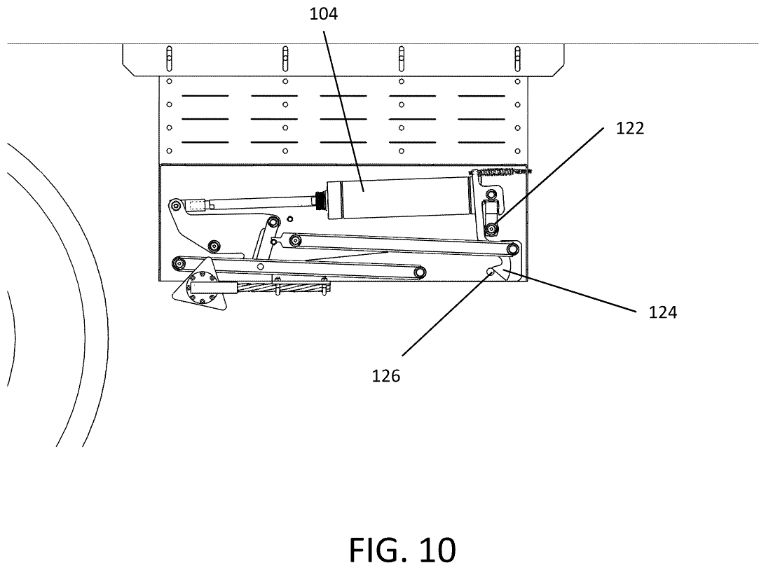

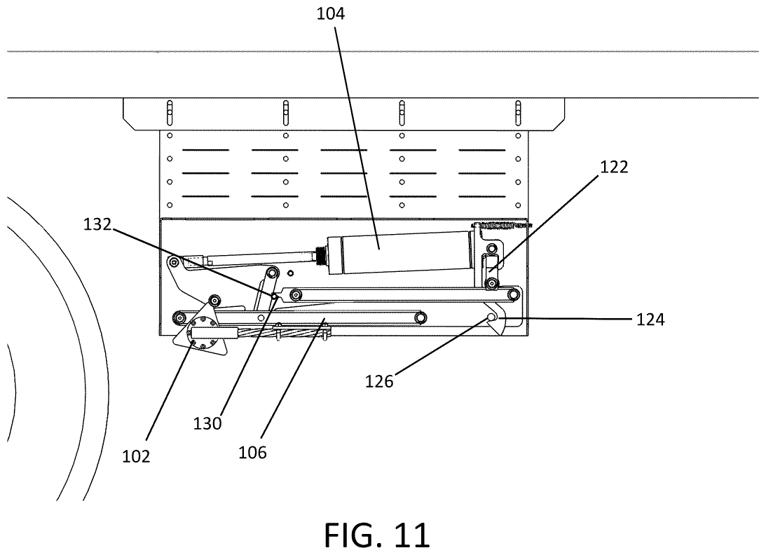

FIG. 8 illustrates the automated wheel chock system 100 beginning a retraction procedure from the fully deployed state. The actuator 104 begins to extend, which forces the pivoting cylinder mount 122 back against the swing stop 123. Then the linkage 106 and wheel chock body 102 begin to retract. As the linkage 106 approaches full retraction as shown in FIG. 9, the latch member 124 engages the latch pin 126. The latch member 124 is pivotable as shown in FIG. 10 to allow a cam surface of the latch member 124 to clear the pin 126 as the linkage continues to retract and the latch member 124 engages the pin 126. The latch member 124 can be spring biased towards the latched state, which is shown in FIG. 11, which corresponds to the fully retracted state for the automated wheel chock system 100. Once fully raised, the retractable latch member 124 snaps over the latch pin 126 to secure the auto chock system 100 in the fully up or retracted position. The vehicle is now ready to be driven.

As shown in FIG. 11, when the chock body 102 and linkage 106 are fully raised, the chock latched confirmation sensor 132 sees the flag 130 and turns off or changes the color of the notification/warning light 128. If the linkage and/or actuator 104 begin to fail and the chock body 102 correspondingly begins to fall, the chock latched confirmation sensor 132 illuminates a dash warning light to notify the driver.

A pair of automated wheel chock systems 100 can be mounted on a vehicle such that each lateral side of the vehicle has one of the automated wheel chock systems 100. In additional embodiments, multiple automated wheel chock systems 100 can be mounted on a common side of the vehicle to engage the tires of each axle. In further embodiments, two automated chocking systems 100 can be mounted to a common side so that a given wheel can be chocked from both front and rear sides of the vehicle. The automated chocking system 100 can be arranged in a mirror image configuration so that chocking a front side of the tire can be accomplished.

A remote control switch or actuator can be disposed in the cab of the vehicle (or other convenient location) so that the driver does not need to exit the vehicle to deploy the automated wheel chock system 100. The remote control actuator can include a duplicate status light(s) similar to that described above.

In a further embodiment, the chock latched confirmation sensor 132 can be connected to the vehicle's own computer control system(s) so that the vehicle can be programmed to not shift out of park and into a drive gear if the automated chock system is not sensed as being in the fully retracted state.

The automated wheel chock system 100 provides the following advantages and/or aspects over conventional wheel chocking methods and systems:
Wheel chocks are deployed and retracted with a press of a button;
Chocks are placed in front and back of rear tires. Systems can be installed on one side or both sides of rear tires for maximum safety;
Saves time, so efficiency is improved;
A removable metal grate and/or screw tire studs and/or snow/ice spikes can be attached to the wheel chock body for icy and snow packed conditions;
The status indicator light provides assurance to dock personnel that the vehicle is chocked; a green and red light system can be provided to display a green light or a red light. Illuminated symbols such as a chock under a wheel can be provided in another alternative to address possible color blind persons);
Avoids risk of human error, laziness, lack of regard for safety and/or being in a hurry trying to speed up the driver's time by skipping the chocking procedure.

While the invention has been described in connection with what is presently considered to be the most practical and preferred example embodiments, it will be apparent to those of ordinary skill in the art that the invention is not to be limited to the disclosed example embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A wheel chock system for mounting on a frame of a vehicle, comprising:
a linkage;
a wheel chock body coupled to the linkage;
an actuator coupled to the linkage; and
a housing secured to the frame of the vehicle,
wherein the linkage is configured to move the wheel chock body between a fully retracted position and a fully deployed position, and
wherein, in the fully deployed position, the wheel chock body is disposed in a nip area between an outer circumference of a tire of the vehicle and a pavement surface.

2. The wheel chock system of claim 1, wherein the housing is sized and shaped to fully enclose the linkage, the actuator and the wheel chock body when the wheel chock body is in the fully retracted position.

3. The wheel chock system of claim 1, wherein the actuator is a pneumatically, hydraulically or electrically driven cylinder with an extendable member.

4. The wheel chock system of claim 1, wherein the wheel chock body is coupled to the linkage via a flexible member.

5. The wheel chock system of claim 1, wherein the linkage comprises:
a bell crank pivotally coupled to the actuator and to the housing;
a crank link pivotally coupled to the bell crank;
a drive link pivotally coupled to the housing on a first end of the drive link, and the drive link coupled to the crank link;
a lower control link, wherein the drive link is pivotally coupled to the lower control link at a second end of the drive link, and wherein the drive link is coupled to the crank link at a location between the first and second ends of the drive link; and
an upper control link pivotally coupled to the housing at a first end of the upper control link and couped to the lower control link at a second end of the upper control link,
wherein the wheel chock body is coupled to the lower control link.

6. The wheel chock system of claim 5, wherein the wheel chock body is coupled to the lower control link via a flexible member spanning between the wheel chock body and the lower control link.

7. The wheel chock system of claim 5, further comprising:
a sensor flag provided to the first end of the upper control link; and
a chock latched sensor provided to the housing,
wherein the chock latched sensor is positioned such that when the wheel chock body is in a fully retracted position, the sensor flag is sensed by the chock latched sensor.

8. The wheel chock system of claim 7, further comprising a status light indicating that the chock latched sensor does not sense the presence of the sensor flag.

9. The wheel chock system of claim 5, further comprising:
a sensor flag provided to the first end of the upper control link; and
a chock down sensor provided to the housing,
wherein the chock down sensor is positioned such that when the wheel chock body is in a fully deployed position, the sensor flag is sensed by the chock down sensor.

10. The wheel chock system of claim 9, further comprising a status light indicating that the chock down sensor senses the presence of the sensor flag.

11. The wheel chock system of claim 9, further comprising a status light indicating that the chock down sensor does not sense the presence of the sensor flag.

12. The wheel chock system of claim 1, further comprising:
a pivoting cylinder mount disposed adjacent to the actuator, the pivoting cylinder mount including a latch member; and
a latch pin disposed on the lower control link in a position such that the latch member engages the latch pin when the wheel chock body is in the fully retracted position.

13. The wheel chock system of claim 1, further comprising:
a pivoting cylinder mount disposed adjacent to the actuator, the pivoting cylinder mount including a latch member; and
a latch pin disposed on the linkage in a position such that the latch member engages the latch pin when the wheel chock body is in the fully retracted position.

14. A method of automatically chocking a wheel of a vehicle, the method comprising:
securing a wheel chock system to a frame of the vehicle;
actuating an actuator to cause a linkage to move a wheel chock body from a fully retracted position towards a fully deployed position;
continuing to the movement of the wheel chock body towards the wheel until the wheel chock body is disposed in a nip area between an outer circumference of a tire on the wheel and a pavement surface; and
maintaining a force on the wheel chock body via the actuator to ensure that the wheel chock body is maintained in the nip area until the actuator is actuated to begin retracting the wheel chock body.

15. The method of claim 14, further comprising sensing with a chock latched sensor that the wheel chock body is in the fully retracted position.

16. The method of claim 14, further comprising sensing with a chock down sensor that the wheel chock body is in the fully deployed position.

17. The method of claim 14, further comprising engaging a pivoting latch member with a latch pin on the linkage to retain the wheel chock body in the fully retracted position.

18. The method of claim 14, further comprising illuminating a status light when the wheel chock body is in the fully deployed position.

19. The method of claim 14, further comprising illuminating a warning light when the wheel chock body is not in the fully retracted position.

20. The method of claim 14, further comprising actuating a switch in a cab or passenger compartment of the vehicle to actuate the actuator.
